(19) United States
(12) Patent Application Publication
(10) Pub. No.: US 2003/0190102 A1
(43) Pub. Date: Oct. 9, 2003

(54) Self-lubricating bearing structure

(75) Inventors: Alex Horng, Kaohsiung (TW); Ching-Shen Hong, Kaohsiung (TW)

Correspondence Address: Bacon & Thomas, 4th Floor, 625 Slaters Lane, Alexandria, VA, 22314, US

(73) Assignee: Sunonwealth Electric Machine Industry Co., Ltd., Kaohsiung (TW)

(21) Appl. No.: 10/116,082

(22) Filed: Apr. 5, 2002

(51) Int. Cl. F16C 33/10

(52) U.S. Cl. 384/292

(57) ABSTRACT

A self-lubricating bearing structure includes a bearing provided with a shaft hole. The shaft hole of the bearing has a wall provided with at least one channel. The channel has a first end passed through the top end face of the bearing, and a second end extended to a position located adjacent to the bottom end of the bearing.

### BACKGROUND OF THE INVENTION

1. Field of the Invention

The present invention relates to a self-lubricating bearing structure, and more particularly to a self-lubricating bearing structure, wherein the lubricating oil contained in the self-lubricating bearing may be used cyclically between the shaft hole of the bearing and the rotation shaft without lost.

2. Description of the Related Art

A conventional self-lubricating bearing or oil-impregnated bearing includes lubricating oil for lubricating and reducing the friction loss of the self-lubricating bearing or oil-impregnated bearing. Thus, it is important to prevent the lubricating oil from being lost, and to reduce the friction loss of the self-lubricating bearing or oil-impregnated bearing. In general, the two ends of the bearing are provided with washers to prevent flowing out of the inner lubricating oil. However, the washers provided on the two ends of the bearing can only delay the inner lubricating oil to flow out, and cannot prevent flowing out of the inner lubricating oil.

FIG. 4 shows a conventional fan structure comprising a blade set 901 combined on a base set 902. The blade set 901 has a rotation shaft 903 whose surface is formed with a helical groove 904. When the rotation shaft 903 is rotated, the lubricating oil between the self-lubricating bearing 905 and the rotation shaft 903 may be introduced to and collected in the oil storage tank 906, thereby reducing loss of the lubricating oil, and thereby lengthening the lifetime of the self-lubricating bearing 905.

The lubricating oil between the self-lubricating bearing 905 and the rotation shaft 903 may be introduced to and collected in the oil storage tank 906 by guidance of the helical groove 904 formed in the rotation shaft 903. However, the inner wall of the shaft hole of the self-lubricating bearing 905 is not provided with a path for guiding and returning the lubricating oil. Thus, the lubricating oil is still lost from the self-lubricating bearing 905 and the rotation shaft 903, thereby affecting the effect of lubricating the rotation shaft 903.

### SUMMARY OF THE INVENTION

The primary objective of the present invention is to provide a self-lubricating bearing structure, wherein the lubricating oil contained in the self-lubricating bearing may be used cyclically between the shaft hole of the bearing and the rotation shaft by guidance of channels provided in the inner wall of the shaft hole of the bearing, so that the lubricating oil will not be lost.

In accordance with the present invention, there is provided a self-lubricating bearing structure, comprising a bearing provided with a shaft hole, the shaft hole of the bearing having a wall provided with at least one channel, the at least one channel having a first end passed through a top end face of the bearing, and a second end extended to a position located adjacent to a bottom end of the bearing.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a self-lubricating bearing structure in accordance with a preferred embodiment of the present invention;

FIG. 2 is a front plan cross-sectional assembly view of the self-lubricating bearing structure as shown in FIG. 1;

FIG. 3 is an expansion view of an inner wall of a bearing of the self-lubricating bearing structure as shown in FIG. 1; and

FIG. 4 is a plan cross-sectional view of a conventional fan structure in accordance with the prior art.

### DETAILED DESCRIPTION OF THE PREFERRED EMBODIMENTS

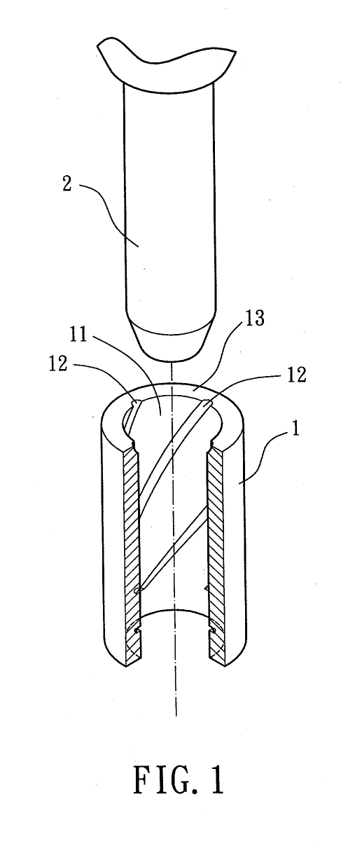

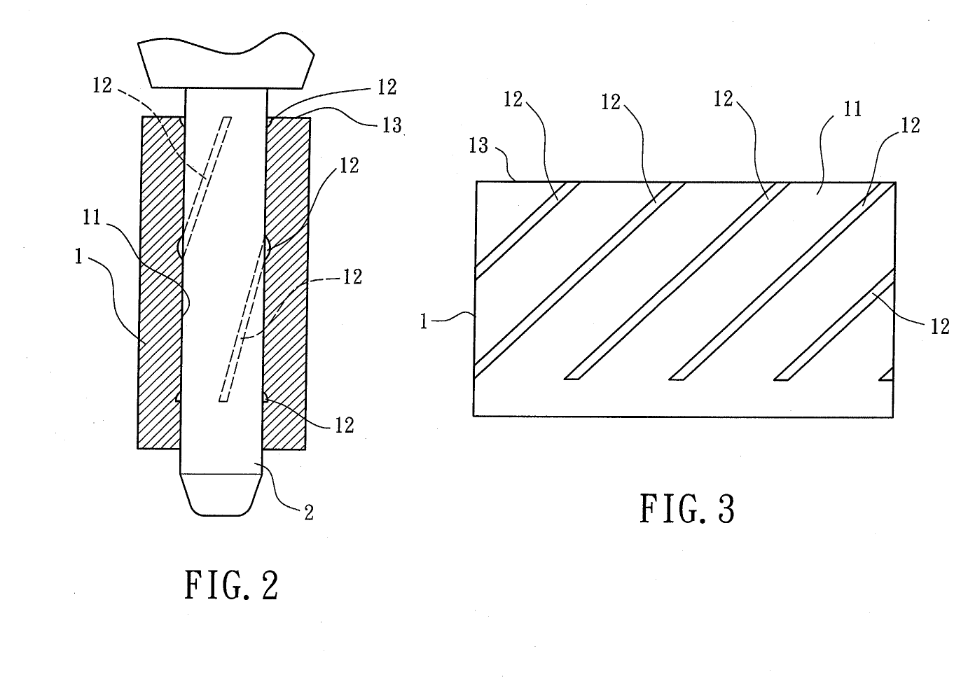

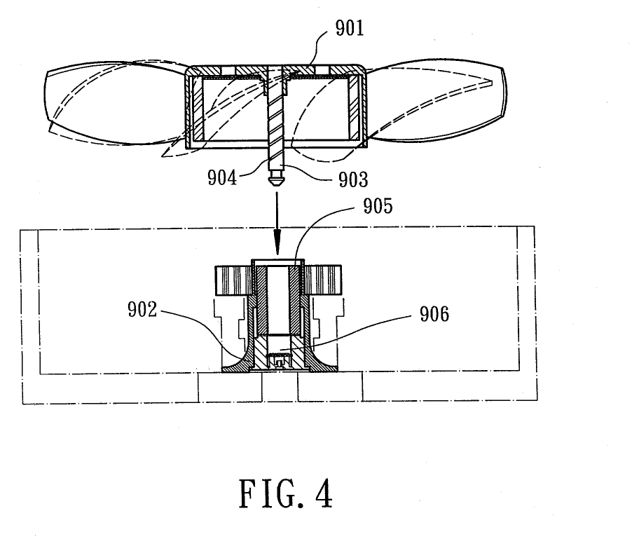

Referring to the drawings and initially to FIG. 1, a self-lubricating bearing structure in accordance with a preferred embodiment of the present invention comprises a bearing 1 provided with a shaft hole 11, and a rotation shaft 2 rotatably mounted in the shaft hole 11 of the bearing 1. The shaft hole 11 of the bearing 1 has a wall face provided with multiple channels 12. Preferably, each of the multiple channels 12 is helical. Each of the multiple channels 12 is extended to a top end face 13 (see FIGS. 2 and 3) of the bearing 1, so that a first end of each of the multiple channels 12 is passed through the top end face 13 of the bearing 1, and a second end of each of the multiple channels 12 is extended to a position located adjacent to a bottom end of the bearing 1. In the preferred embodiment of the present invention, the first end of each of the multiple channels 12 is inclined with the top end face 13 of the bearing 1, with a non-right-angle included angle being formed therebetween.

Referring to FIG. 2, when the rotation shaft 2 is rotated in the shaft hole 11 of the bearing 1, the lubricating oil contained in the bearing 1 will rise along the space between the rotation shaft 2 and the bearing 1 by rotation of the rotation shaft 2. When the rising lubricating oil meets the channel 12, the rising lubricating oil will enter the channels 12, and will return to the bottom of the channel 12 by guidance of the channel 12. Thus, the lubricating oil is collected in the bottom of the channel 12. When the lubricating oil is collected in the bottom of the channel 12 to have a determined amount, the lubricating oil will be driven by the rotating rotation shaft 2 to again rise along the wall of the shaft hole 11 of the bearing 1 by rotation of the rotation shaft 2. Thus, the lubricating oil will cycle between the rotating rotation shaft 2 and the inner wall of the shaft hole 11 of the bearing 1, so that the lubricating oil contained in the bearing 1 will not be lost, thereby further increasing the lifetime of the bearing 1.

Accordingly, in the self-lubricating bearing structure in accordance with a preferred embodiment of the present invention, the inner wall of the shaft hole of the bearing is provided with channels. Thus, when the rotation shaft is rotated in the shaft hole of the bearing, the lubricating oil contained in the bearing will return cyclically by guidance of the channels. In addition, the second end of each of the multiple channels is extended to a position located adjacent to the bottom end of the bearing, and is not passed through the bottom end face of the bearing. Thus, the bottom of the channel may be used to collect the lubricating oil. Thus, the collected lubricating oil may be carried away by rotation of the rotation shaft, and will rise along the inner wall of the shaft hole, and then enter the channel to return cyclically. Thus, the lubricating oil contained in the bearing will not be lost, so as to maintain the self-lubricating function of the bearing, thereby further increasing the lifetime of the bearing.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A self-lubricating bearing structure, comprising a bearing provided with a shaft hole, the shaft hole of the bearing having a wall provided with at least one channel, the at least one channel having a first end passed through a top end face of the bearing, and a second end extended to a position located adjacent to a bottom end of the bearing.

2. The self-lubricating bearing structure as claimed in claim 1, wherein the at least one channel is helical.

3. The self-lubricating bearing structure as claimed in claim 1, wherein an included angle is formed between the at least one channel and the top end face of the bearing, and is a right angle.

4. The self-lubricating bearing structure as claimed in claim 1, wherein an included angle is formed between the at least one channel and the top end face of the bearing, and is a non-right-angle.
